(19) United States
(12) Patent Application Publication
(10) Pub. No.: US 2022/0070736 A1
(43) Pub. Date: Mar. 3, 2022

(54) TRAFFIC STEERING DEVICE

(71) Applicant: Telefonaktiebolaget LM Ericsson (publ), Stockholm (SE)

(72) Inventors: Ala NAZARI, Handen (SE); Marcus IHLAR, Älvsjö (SE); Massimo CONDOLUCI, Solna (SE); Robert SKOG, Hässelby (SE); Vicknesan AYADURAl, Sollentuna (SE)

(73) Assignee: Telefonaktiebolaget LM Ericsson (publ), Stockholm (SE)

(21) Appl. No.: 17/291,193

(22) PCT Filed: Nov. 5, 2018
(86) PCT No.: PCT/SE2018/051129

§ 371 Date: May 4, 2021

(51) Int. Cl. H04W 28/24; H04W 28/08; H04W 28/02

(52) U.S. Cl. CPC H04W 28/24; H04W 28/0284; H04W 28/0925

(57) ABSTRACT

Embodiments described herein provide methods and apparatus for transmitting traffic between a Customer Premises Equipment (CPE) apparatus and a communications network. The method comprises receiving traffic from a user device at the CPE apparatus; providing a first link configured to transmit the traffic to the communications network using a first communications technology; providing a second link configured to transmit the traffic to the communications network using a second communications technology; receiving a rule from the communications network at the CPE apparatus for use in transmitting the traffic to the communications network; and selecting to transmit the traffic to the communications network using the first link, the second link or both the first link and the second link, based on the received rule.

### TECHNICAL FIELD

Embodiments disclosed herein relate to methods and apparatus for transmitting traffic between a Customer Premises Equipment (CPE) apparatus and a communications network using a first communications technology and a second communications technology. In particular, methods and apparatus described herein provide selective transmission of traffic using the first communications technology and/or the second communications technology.

### BACKGROUND

It is common for a customer premises to be connected to the Internet via a fixed wired connection, for example, an asymmetric digital subscriber line (ADSL) or cable. These fixed wired technologies provide a consistent connection between the customer premises and an Internet service provider (ISP) or operator.

With rapid developments in the world of cellular communications and an emergence of newer generation technologies, such as 5G, mobile broadband connectivity is becoming a viable alternative for fixed customer premises, just as it already is for customers using wireless technologies, for example with smart mobile devices.

It is also common for a telecom operator to operate both a wired network, e.g., using ADSL technology, as well as a cellular network, e.g., using Long Term Evolution (LTE) technology. In such scenarios, with the infrastructure already in place, the operator may be able to provide connectivity to the Internet on both these networks to the end user, in the form of hybrid access or fixed-mobile convergence. A multi-access connection such as this, may often be beneficial, particularly in terms of reliability and speed.

The control plane, in for example a 5G network, controls packet processing at the user plane by provisioning the user plane with various rules. The control plane controls the packet processing in the user plane by establishing, modifying or deleting a Packet Forwarding Control Protocol (PFCP) Session contexts and by provisioning (i.e. adding, modifying or deleting) Packet Detection Rule (PDRs), Forwarding Action Rule (FARs), QoS Enforcement Rule (QERs), Usage Reporting Rule (URRs) and/or Buffering Action Rules (BARs) per PFCP session context.

A PFCP session context may manifest itself in a number of ways. For example, for an Evolved Packet Core (EPC) node to an individual Public Data Network (PDN) connection, the PFCP context may correspond to a Traffic Detection Function (TDF) session, or a standalone session not tied to any PDN connection or TDF session used e.g. for forwarding Radius, Diameter or Dynamic Host Configuration Protocol (DHCP) signalling between the PDN Gateway Control (PGW-C) and the PDN. In another example, for 5GC, the PFCP session context may correspond to an individual Protocol Data Unit (PDU) session or a standalone PFCP session not tied to any PDU session.

Each PDR may comprise packet detection information (PDI), for example, one or more matching fields against which incoming packets are matched. Each PDR may also be associated to a number of rules providing a set of instructions to apply to packets matching the PDI. These rules may comprise FARs, QERs and URRs.

Each PDR may comprise one FAR which may comprise instructions related to the processing of packets. One instruction of the FAR is, for example, an Apply Action parameter, which indicates whether the User Plane (UP) function should forward, duplicate, drop or buffer the packet with or without notifying the Control Plane (CP) function about the arrival of a downlink (DL) packet. Another instruction of the FAR may be, for example, forwarding, buffering and/or duplicating parameters, which the UP function shall use if the Apply Action parameter requests the packets to be forwarded, buffered or duplicated respectively. These parameters may remain configured in the FAR regardless of the Apply Action parameter value, to minimize the changes to the FAR during the transitions of the User Equipment (UE) between the idle and connected modes. The buffering parameters, when present, may be provisioned in a BAR created at the PFCP session level and referenced by the FAR.

Each PDR may also comprise one or more QERs, which contain instructions related to the QoS enforcement of the traffic. Each PDR may further comprise one or more URRs, which contain instructions related to traffic measurement and reporting.

Numerous PDRs with associated rules may be defined for e.g. service subscription flows, Over-The-Top (OTT) application flows (with e.g. OTT collaboration), sponsored data flows, subscriber profiling flows (from Analytics) as well as trained flows (from heuristic Deep Packet Inspection (DPI) and machine learning).

### SUMMARY

According to some embodiments there is provided a method of transmitting traffic between a Customer Premises Equipment (CPE) apparatus and a communications network. The method comprises receiving traffic from a user device at the CPE apparatus; providing a first link configured to transmit the traffic to the communications network using a first communications technology; providing a second link configured to transmit the traffic to the communications network using a second communications technology; receiving a rule from the communications network at the CPE apparatus for use in transmitting the traffic to the communications network; and selecting to transmit the traffic to the communications network using the first link, the second link or both the first and second link, based on the received rule.

According to some embodiments there is provided a CPE apparatus for transmitting traffic between a user device and a communications network. The CPE apparatus comprises an input configured to receive traffic from the user device; a first link configured to transmit the traffic to the communications network using a first communications technology; a second link configured to transmit the traffic to the communications network using a second communications technology; and processing circuitry configured to: receive a rule from the communications network for transmitting the traffic; and select the first link, the second link or both the first and the second link to transmit the traffic to the communications network, based on the rule.

According to some embodiments there is provided a method in a communications network node comprised in a communications network, of controlling transmission of traffic from a user device to the communications network, via a Customer Premises Equipment, CPE, apparatus, wherein the communications network is configured to receive the traffic from the CPE apparatus using: a first link using a first communications technology, a second link using a second communications technology or both the first link and the second link. The method comprises determining, by the communications network node, a rule for transmitting the traffic; and providing the rule to the CPE apparatus for transmitting the traffic from the user device to the communications network; and wherein the rule comprises an indication for the CPE apparatus to transmit the traffic to the communications network using the first link, the second link or both the first link and the second link.

According to some embodiments there is provided a communications network node, in a communications network, configured to control transmission of traffic from a user device to the communications network, via a Customer Premises Equipment, CPE, apparatus wherein the communications network is configured to receive the traffic from the CPE apparatus using: a first link using a first communications technology, a second link using a second communications technology or both the first link and the second link. The communications network node comprises processing circuitry configured to: determine a rule for transmitting the traffic; and transmit the rule to the CPE apparatus for transmitting the traffic from the user device to the communications network; wherein the rule comprises an indication for the CPE apparatus to transmit the traffic to the communications network using the first link, the second link or both the first link and the second link.

### BRIEF DESCRIPTION OF THE DRAWINGS

For a better understanding of the present invention, and to show how it may be put into effect, reference will now be made, by way of example only, to the accompanying drawings, in which: FIG. 1 illustrates an example of a network for connecting a user device to a communications network;

FIG. 2 illustrates an example of a method of transmitting traffic from a CPE apparatus to a communications network;

FIG. 3 illustrates another example of a network for connecting a user device to a communications network;

FIG. 4 illustrates an example of a CPE apparatus forwarding packets between a user device and a communications network;

FIG. 5 illustrates an example of a method in a communications network node of receiving traffic from a user device via a CPE apparatus;

FIG. 6 illustrates an example of a CPE apparatus for transmitting traffic between a user device and a communications network; and

FIG. 7 illustrates an example of a communications network node configured to receive traffic from a user device via a CPE apparatus.

### DESCRIPTION

The following sets forth specific details, such as particular embodiments for purposes of explanation and not limitation. But it will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

FIG. 1 illustrates an example of a network 100 for connecting a user device 110 to a communications network 120. The communications network may comprise the internet 121, or may be connected to the internet or cloud based services. The user device 110 may comprise a smart phone or tablet device 112, a laptop or PC device 114 or smart television device 116. User device 110 may comprise any other type of device capable of establishing a connection with communications network 120. In the example network 100, the user device 110 may be situated at a user premises. To connect to the communications network 120, the user device 110 may first establish a connection a Customer Premises Equipment (CPE) apparatus 130.

The CPE apparatus 130 may be placed at the user premises and may establish connection to user device 110 over a common home network link 140. The CPE apparatus 130 may comprise two communication links to the communications network 120. In particular, the CPE apparatus 130 may be provided with a first link 150a, which may be a fixed wired ADSL connection, and a second link 150b, which may be a cellular mobile broadband connection. It will be appreciated that, in some examples, the CPE 130 may provide two or more wireless connections, or two or more wired connections, or any combination thereof. The communications network node 160 may then establish communication between the user device 110 and the communications network 120 from traffic received using the provided links. The communications network node 160 may comprise a user plane function (UPF) capable of performing an aggregation of the traffic received over the first link 150a and the second link 150b, for transmission of the traffic to the communications network 120 using any suitable connection.

In conventional methods, where multiple connections are available to the CPE apparatus 130 for transmitting traffic to the communications network 120, the CPE apparatus 130 transmits traffic over all available connections. In particular, where a wired connection and a wireless connection are available to the CPE apparatus 130, the CPE apparatus 130 would conventionally transmit traffic to the communications network 120 over both the wired connection and the wireless connections. In some examples, a multi-access connectivity such as this may be beneficial.

However, a user's quality of experience may be related to the type of traffic being transmitted. For example, the type of traffic may include real-time video, tactile traffic, web browsing, virtual reality (VR) or augmented reality (AR). The traffic type may affect a user's experience as the type of traffic may affect a number of metrics such as delays, latency, and losses. In particular, some applications with certain traffic requirements may achieve better performance and may provide a better user experience if provided on only one link, or on only a select number of links. For example, certain traffic requirements may achieve better performance if only wired links are used, or equivalently only wireless links are used.

Furthermore, certain network links generally carry a certain financial cost for the user to operate, or a certain network cost to the mobile network operator to operate. In particular, some communications links may be associated with different costs to other communication links. Therefore, in some networks, it may be beneficial for the network to use ‘cheaper’ communication links when a user's traffic requirements are low, so as to more efficiently use available resources.

Therefore, in some examples, it may not always be most beneficial for a user's experience or the network as a whole, to communicate traffic between a user device and a communications network using multiple connections.

A method of steering traffic to be transmitted on selected links in certain applications may therefore be desirable. It would be beneficial to provide this functionality at the CPE to steer traffic from a user device to the communications network using certain links in certain situations. However, Over-the-top (OTT) applications dominate user traffic in modern-day networks and the data flows of OTT traffic are mostly encrypted. A CPE only provides a relatively shallow deep packet inspection (DPI) to retrieve information in each packet comprised in the traffic. The DPI of the CPE is generally not deep enough to detect the application protocol of a traffic flow, and therefore the CPE may not easily exert control on different traffic flows as it is unaware of the different added application traffic types. Furthermore, a CPE is not generally provided with sophisticated enough circuitry to perform such analysis.

Furthermore, it is even harder to detect OTT application flows when the server name indication (SNI) is also encrypted. It would be beneficial to determine this information for traffic steering and management at the CPE.

However, in accordance with embodiments described herein, the CPE apparatus may be configured to select to send traffic on a first link, a second link or both the first and second link. The selection to send the traffic using a chosen link configuration may be made based on rules, which are determined by the communications network and sent to the CPE apparatus. The rules may be determined by the communications network based on the type of traffic, as well as network-wide considerations and policy factors.

The rules may define how certain traffic is to be communicated between a user device and a communications network. When the CPE apparatus receives traffic from a user device it may match the traffic to a specific rule. The traffic may then be forwarded to the communications network according to the rule, which provides an indication of whether the traffic should be sent using a first link, a second link or both the first and second links. Providing this rule-based approach to transmitting traffic between a user device and a communications network may provide numerous benefits in terms of user-experience and to more efficient use of network resources.

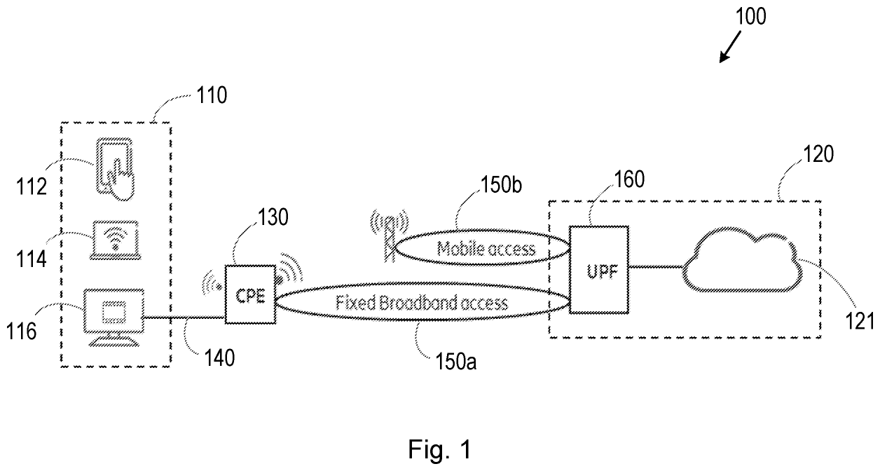

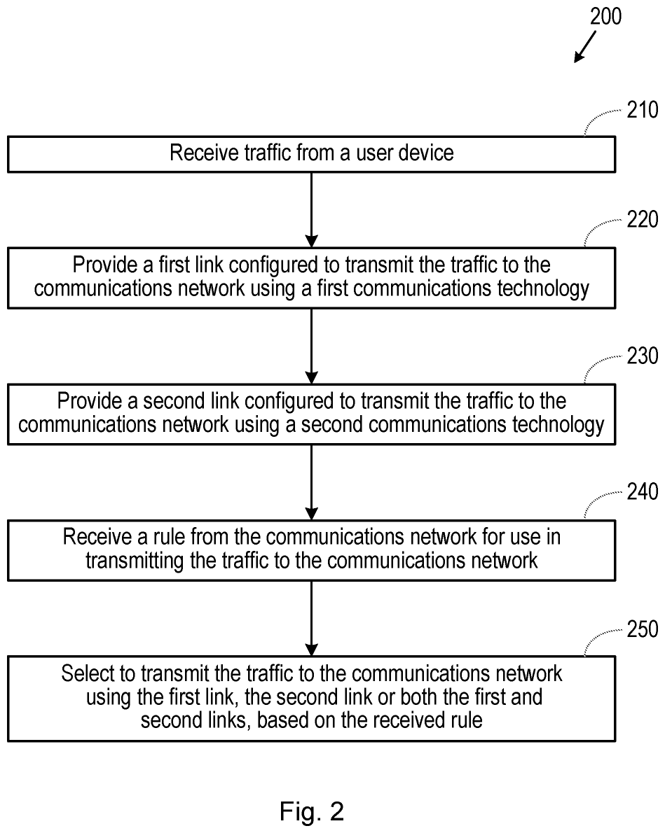

FIG. 2 illustrates an example of a method 200 of transmitting traffic from a CPE apparatus to a communications network, in accordance with embodiments of the present disclosure.

In step 210, the method comprises receiving traffic from a user device at the CPE apparatus.

In step 220, the method comprises providing a first link configured to transmit the traffic to the communications network using a first communications technology.

In step 230, the method comprises providing a second link configured to transmit the traffic to the communications network using a second communications technology.

In step 240, the method comprises receiving a rule from the communications network at the CPE apparatus for use in transmitting the traffic to the communications network.

In step 250, the method comprises selecting to transmit the traffic to the communications network using the first link, the second link or both the first and second links, based on the received rule.

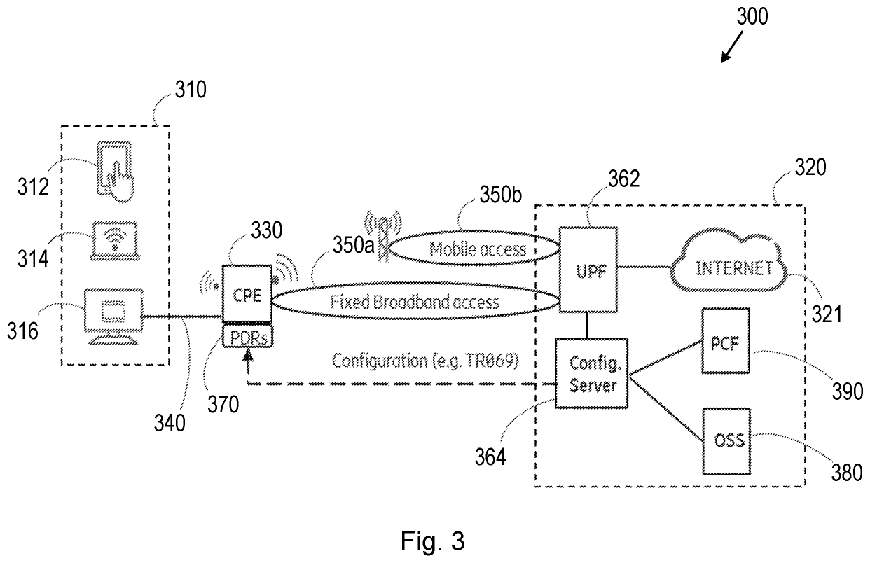

FIG. 3 illustrates an example of a network 300 connecting a user device 310 to a communications network 320. User device 310 requests to join the communications network 320 and transmits traffic to the communications network 320 via the CPE apparatus 330. First link 350a using a first communications technology is provided for transmitting traffic between CPE apparatus 330 and communications network 320. Second link 350b using a second communications technology is also provided for transmitting traffic between CPE apparatus 330 and communications network 320.

The communications network 320 may comprise a UPF 362 configured to receive the traffic over the first link and the second link, and aggregate the received traffic for forwarding to the internet 321.

In this example, the first communications technology comprises a wired technology and the second communications technology comprises a wireless communications technology. However, it will be appreciated that both the first communications technology and the second communications technology may both be wired technologies, or both be wireless technologies.

In conventional networks, the CPE apparatus 330 would transmit traffic from the user device 330 to communications network 320 using both the first link 350a and the second link 350b. According to examples disclosed herein, the communications network 320 provisions the CPE apparatus 330 with a rule 370. In one example, the communications network 320 is operated by a network operator. In some examples, the communications network 320 may determine a plurality of rules and transmit the plurality of rules to the CPE apparatus 330. The rule 370 is determined by the communications network 320 and provides instructions for how the traffic may be transmitted between the CPE apparatus 330 and the communications network 320. In particular, the rule 370 may comprise instructions for the CPE apparatus 330 to select to transmit certain traffic types to the communications network 320 using the first link 350a, the second link 350b or both the first link 350a and the second link 350b.

The communications network 320 may comprise a UPF node 362 capable of performing the aggregation of the traffic received over the first link 350a and the second link 350b, for further transmission to the internet 321. The communications network 320 further comprises a network node 364, which may be configured to determine the rule 370 and provision the rule 370 to the CPE apparatus 330. The network node 364 may comprise a configuration sever 364.

As described above, the DPI of the CPE apparatus 330 may be too shallow to determine detailed information of traffic received at the CPE apparatus. Furthermore, as the majority of traffic is from OTT application flows, such flows are encrypted making it more difficult to determine detailed traffic characteristics.

The configuration server 364 may therefore be configured to determine detailed traffic characteristics. In one example, the configuration server 364 communicates with an Operations Support System (OSS) 380 to retrieve traffic characteristics. The OSS 380 may be aware of the traffic that is being communicated in the network. The OSS 380 may therefore be able to supply the traffic characteristics of the traffic flows to the configuration server 364. In some examples, the traffic characteristics may comprise application traffic types, traffic size, traffic cost, traffic bitrate and traffic destination.

In one example, the UPF 362 may determine traffic characteristics by analysing network traffic patterns and may be configured to communicate the determined traffic characteristics to the configuration server 364. The UPF 362 may be configured with machine learning capabilities and/or heuristic detection. The UPF 362 may then be configured to analyse network traffic patterns through machine learning and/or heuristic detection and further be configured to communicate the traffic characteristics to the configuration server 364. For example, from machine learning analysis, the UPF 362 may determine that a particular user may regularly transmit or receive a certain traffic flow, or a certain traffic type, for example video traffic. The UPF may communicate this information to the configuration server 364 such that the configuration server may provision the rule 370 according to the traffic characteristic. Therefore, when the same user transmits an initial request to receive traffic from the communications network 320, the configuration server 364 may therefore determine that the same user may most likely be requesting video traffic and configure the appropriate rule 370 for the traffic requested by the user.

Once the configuration server 364 has obtained traffic characteristics of the traffic, for example from the UPF 362, the configuration server 364 may then assign the rule 370 for transmitting the traffic based on the traffic characteristics. In other words, to determine the rule 370 for transmitting traffic, the configuration server 364 may obtain traffic characteristics of the traffic and assign the rule for transmitting the traffic based on the traffic characteristics. In one example, the configuration server 364 obtains the traffic characteristics from the UPF 362 or the PCF 390. In one example, to determine the traffic characteristics, the PCF 390 may communicate with an OTT applications server. In another example, to determine the traffic characteristics, the UPF 362 may analyse network traffic patterns.

In some examples, the configuration server 364 may be configured to determine the rule 370 for transmitting traffic, based on network characteristics. In some examples, network characteristics may comprise a cost, latency, transmission rate and bandwidth associated with the first link 350a; a cost, latency, transmission rate and bandwidth second link 350b; and/or a cost, latency, transmission rate and bandwidth associated with user device 310.

The configuration server 364 may be configured with a network operator that has access to numerous network characteristics, which may affect how the rules are assigned for certain traffic types. For example, first link 350a may comprise a lower cost than second link 350b. In such an example, the rule 370 may be assigned for transmitting ‘cheaper’ traffic on the first link 350a and more ‘expensive’ traffic types using second link 350b. In other words, the configuration server 364, may determine network characteristics and assign the rule for transmitting the traffic based on the network characteristics.

In some examples, the configuration server 364 may be configured to determine the rule 370 for transmitting traffic based on a policy to apply to the traffic, and may assign the rule for the traffic based on the policy. In certain circumstances, a particular policy may need to be applied to the traffic based on e.g. line-subscription, time-of-day or application performance. In one example, the configuration server 364 may communicate with a policy control function (PCF) node 390. PCF node 390 may be able to determine network information and network characteristics. The network characteristics may then be used by the PCF node to determine policy rules, which may then be used to determine the rule 370 for transmitting traffic. In one example, the PCF node 390 may provision the configuration server 364 with policy rules. The configuration server 364 may then use the policy rules to determine the rule 370 for transmitting the traffic.

In one example, the configuration server 364 may use traffic characteristics, network characteristics and/or policy rules for determining the rule 370 for transmitting traffic.

In one example, the CPE apparatus 330 may transmit a request to communications network 320 for the rule 370. The CPE apparatus 330 may request the rule 370 upon initialization of the CPE apparatus 330. In another example, the CPE apparatus 330 may request the rule 370 upon a request from user device 310 to connect to communications network 320.

The rule 370 may then be transmitted to CPE apparatus 330 for transmitting traffic between the user device 310 and the communications network 320. With the rule 370 received at the CPE apparatus 330, the CPE apparatus 330 may then be configured to transmit traffic between the user device 310 and the communications network 320 according to the rule 370. In particular, the rule 370 provides instructions for transmitting each packet comprised in the traffic.

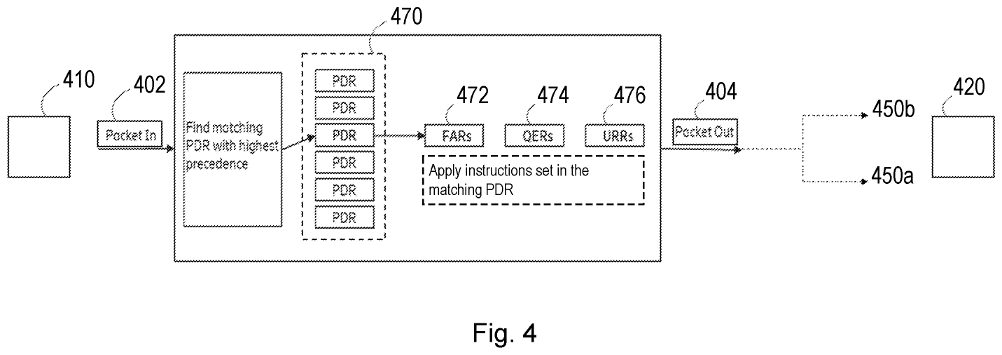

FIG. 4 illustrates an example of a CPE apparatus 430 forwarding packets between a user device 410 and a communications network 420. The CPE apparatus 430 comprises a plurality of rules 470. In one example, the rules 470 have been transmitted to the CPE apparatus 430 from the communications network 420. The CPE apparatus 430 comprises a first link 450a using a first communications technology and a second link 450b using a second communications technology. In one example, the first link 450a comprises a wired connection and the second link 450b comprises a wireless connection.

The rules 470 comprise instructions for transmitting traffic between the user device 410 and a communications network 420 and may comprise instructions for transmitting traffic using the first link 450a, the second link 450b or both the first link 450a and second link 450b. The rules 470 may comprise instructions and further rules for transmitting packets comprised in traffic between the user device 410 and communications network 420.

In one example, the CPE apparatus 430 may receive the plurality of rules 470 from the communications network 420, match the traffic to a corresponding rule in the plurality of rules and transmit the traffic to the communications network 420 according to the corresponding rule.

In some examples, the rules 470 may comprise packet detection rules (PDRs) for traffic enforcement and traffic steering at the CPE apparatus 430. The PDRs may be defined based on 3GPP Technical Standard 29.244. Each PDR may comprise packet detection information (PDI). The PDI of each PDR may comprise one or more match fields against which an incoming packet is matched and the matched packet is subsequently processed according to the instructions and rules comprised in the PDR.

Each PDR may be associated with a number of further rules for processing a corresponding packet. Referring again to FIG. 4, each PDR may comprise one forward action rule (FAR) 472, which comprises instructions related to the forwarding of the packets. In other words, the rule 470 may comprise a PDR comprising a FAR, wherein the FAR comprises an indication for transmitting the traffic using the first link, the second link or both the first and second links. The FAR 472 may comprise forwarding parameters, examples of which include a destination interface and instructions for the creation of an outer header.

The PDR may also comprise a QoS enforcement rule (QER) 474, which may comprise instructions related to the QoS enforcement of the traffic. The QER 474 may also comprise instructions on transport-level marking e.g. Differentiated Services Code Point (DSCP). The PDR may further comprise a usage reporting rule (URR) 476, which may comprise instructions related to traffic measurement and reporting.

The communications network 420 may provision the CPE apparatus 430 with the rules 470 through a control or management configuration interface. In one example, the configuration interface may correspond to the technical report 069 (TR-069) standard. In one example, the CPE apparatus 430 may request the rules 470 upon the initialization of the CPE apparatus 430. In another example, the CPE apparatus 430 may request the rules 470 upon request from the user device 410 to connect to the communications network 420.

In creating and provisioning the rules 470 by the communications network 420 to the CPE apparatus 430, the communications network 420 may follow a number of principles. One principle may be that the communications network 420 may not provision more than one PDR with the same match fields in the PDI i.e. no two PDRs may be provisioned with exactly the same set of match fields and with exactly the same values. The communications network 420 may provision PDRs with the same value for a subset of the match fields of the PDI, but not all of the match fields.

Another principle may be that the match fields of different PDRs may overlap i.e. one PDR (PDRa) may comprise all of the same match fields with same values as another PDR (PDRb). However, PDRa may then comprise an additional match field that is not present in PDRb. Thus, two such PDRs will overlap, but may not comprise exactly the same match fields.

A further principle may be that the communications network 420 may provision a PDR with all match fields wild-carded i.e. with all match fields omitted from the PDI. Such PDRs may be used to control how packets which are unmatched to any PDRs will be forwarded. These wild-carded PDRs may be granted the lowest precedence for matching by the communications network 420.

Referring to FIG. 4, the CPE apparatus 430 may receive a packet 402 at an input of the CPE apparatus 430. In one example, the packet in 402 may be transmitted from a user device 410 for transmission to a communications network 420. On receipt of packet 402, the CPE apparatus 430 may perform a lookup operation of the rules 470 to match the incoming packet 402 to a corresponding rule of the rules 470 to transmit the packet to the communications network according to the corresponding rule.

In one example, the CPE apparatus 430 may find the first PDR matching the incoming packet 402 among the PDRs provisioned by the communications network 420 to the CPE apparatus 430. The CPE apparatus 430 performs the lookup operation starting with the PDR with the highest precedence and may then continue the lookup operation, PDR by PDR, according to the decreasing precedence order. Once the CPE apparatus 430 has matched the packet 402 to a matching PDR, following the precedence-based lookup operation, the CPE apparatus will then halt the lookup operation, selecting the matching PDR to apply to the incoming packet 402.

The incoming packet 402 comprises a packet header, which may comprise packet fields. The CPE apparatus 430 may use the packet fields of the packets and the match fields of the PDRs to determine which PDR the incoming packet 402 should be matched with. In one example, to match traffic to a corresponding rule, the CPE apparatus 430 may read a packet header of a data packet in the traffic comprising packet information, and may match each data packet to the respective corresponding rule, based on the respective packet information. In another example, the packet information comprises at least one packet field and the CPE apparatus 430 may match a data packet to the corresponding rule by determining that the at least one packet field of the data packet matches the at least one match field of the corresponding rule.

The packet 402 may be matched to a corresponding PDR in a number of ways. In one example, the packet 402 matches a PDR if all the match fields of the PDI of the PDR match the corresponding packet header fields of the packet 402. In another example, if the match fields of a PDR match all the corresponding header fields of the packet 402, but the packet 402 comprises an additional header field, and the PDR does not comprise the corresponding match field to the additional header field, then the packet 402 will be considered to match such a PDR.

In another example, the match field of a PDR may comprise a mask. For example, a mask may comprise a prefix mask to mask a full IP address. If a match field of a PDR is present, and includes a mask, the match field shall be considered as matching a corresponding header field of the packet 402, if the packet field has the same value for the bits which are set in the mask. In another example, if a match field in the PDR is present and does not include a mask, the match field shall be considered as matching a corresponding header field of the packet 402 if the two fields have the same value.

If the CPE apparatus 430 determines that none of the provisioned PDRs match the incoming packet 402, then the incoming packet 402 may be dropped and not forwarded on to the communications network 420.

Referring to FIG. 4, once the incoming packet 402 has been matched to a corresponding PDR by the lookup operation of the CPE apparatus 430, the packet 402 may be forwarded and processed according to the rules and instructions of the matched PDR. In one example, the PDR may comprise a FAR 472, a QER 474 and a URR 476, which may comprise instructions for forwarding and processing the incoming packet 402. In one example, the PDR may comprise the FAR 472 and may not comprise a QER 474 and a URR 476. In another example, the PDR may comprise a FAR 472 and a QER 474 or a URR 476. Once the incoming packet 402 has been processed according to the corresponding PDR as described above, the packet may be transmitted from the CPE apparatus 430 as an outbound packet 404.

FIG. 4 illustrates the example of the CPE apparatus 430 processing uplink traffic from the user device 410 to the communications network 420. In this example, the CPE apparatus 430 may select the appropriate link configuration to select for transmitting the traffic to the communications network 420, according to the corresponding rule. In another example, the CPE apparatus 430 may receive downlink traffic from the communications network 420, to transmit to the user device 410. In this example, the traffic will have already travelled to the CPE apparatus 430 using the first link 450a, second link 450b or both the first link 450a and second link 450b. However, the CPE apparatus 430 may still match traffic travelling in the downlink direction to a corresponding rule for processing the traffic. In such examples, packets of the traffic travelling in the downlink direction may be matched in the same way as packets travelling in the uplink direction. However, the CPE apparatus will not generally select a link to transmit the downlink traffic to the user device as only a single link via a home network is provided between the CPE apparatus 430 and the user device 410.

For the downlink traffic, the PDRs control the QoS to be assigned to different types of packets. For example a particular QoS may be assigned to a packet comprising video, whilst another QoS may be assigned to a packet comprising VR. In conventional home network and CPE apparatus systems, QoS assignment may operate on a best-effort delivery basis, meaning that all traffic has equal priority. However, this means that, in times of congestion, all traffic has an equal chance of being dropped. In some examples, certain traffic types or flows may carry more importance than others. However, using conventional systems, the less important traffic flows have an equal chance of being dropped as the more important traffic flows.

Therefore, in examples presented herein the PDRs may comprise QERs that enable prioritized delivery of downlink traffic from a communications network to a user device on a home network. The CPE apparatus 430 may be configured to match an inbound downlink packet from a communications apparatus 420, to a corresponding PDR of a plurality of PDRs using a lookup operation. The PDR may then comprise a QER for a given packet type, which governs the QoS to be assigned to the given packet. The packet may then be transmitted to a user device 410 on a home network according to the QoS defined by the QER. In this way, certain traffic types may be given prioritized delivery compared to other traffic types. In one example, the QoS assigned to a given downlink packet by a QER may be based at least in part, on whether the packet was received via the first link 450a, second link 450b or both the first link 450a and second link 450b. In other words, the rule 470 may comprise a quality of service, QoS, rule for prioritising downlink traffic from the communications network 420 to the user device 410 and downlink traffic received from the communications network 420 at the CPE apparatus 430 may be transmitted to the user device 410 based on the QoS rule.

In one example, the traffic steering and matching capabilities of the CPE apparatus 430 may manifest themselves in a flow classifier module comprised in the CPE apparatus 430. The flow classifier module may read packet headers and match different packet types to corresponding rules. The link selection capabilities of the CPE apparatus 430 may manifest themselves in a link selector module comprised in the CPE apparatus 430. The link selector module may be able to select the first link 450a, second link 450b or both the first link 450a and the second link 450b according to the corresponding rule for a packet. The CPE apparatus may further comprise a configuration module for controlling the flow classifier module and link selector module. In one example, the configuration module may be managed by the network operator.

Referring again to FIG. 3, in some examples, the communications network 320 may provision the CPE apparatus 330 with an updated rule. The rules may be updated in response to network change. For example, an additional user device may request to connect the communications network 320 and updated rules may be configured in response to such a change. Therefore, in one example, the CPE apparatus 330 may receive an updated rule from the communications network 320 in response to a trigger.

The configuration server 364 may be configured to detect the trigger, determine an updated rule in response to the trigger and transmit the updated rule to the CPE apparatus 330.

In some examples, the trigger may comprise a network change e.g. an additional user device requesting to connect to the communications network 320 via the home network 340. Another example of a network change, may be an update of the network. A further example may be an additional link provided between the CPE apparatus 330 and the communications network 320. In another example, the trigger may comprise a network failure. For example a fault may occur in first link 330a and/or second link 330b. In another example, the trigger may comprise a new or additional traffic flow being determined by the communications network 320. In such examples, the configuration server 364 may provision the updated rule to the CPE apparatus 330 unsolicited by the CPE apparatus 330. In a further example, the trigger may comprise a periodic trigger. In such examples, the rules may be updated periodically. This may be to control how traffic is split across the available links depending on the time of day.

In some examples, the updated rule may replace the rule 370. For example, a new set of PDRs may be provisioned in response to a link failure. In another example, the updated rule may be configured in addition to the rule for use in transmitting traffic to the communications network. For example, new PDRs may be provisioned in addition to the presently maintained PDRs, in response to an additional user device requesting to join the communications network.

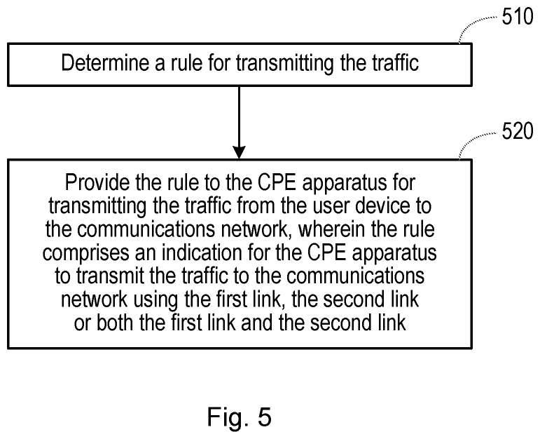

FIG. 5 illustrates an example of a method 500 in a network node (for example the configuration server 364) comprised in a communications network, of controlling transmission of traffic from a user device to the communications network, via a CPE apparatus, wherein the communications network is configured to receive the traffic from the CPE apparatus using: a first link using a first communications technology, a second link using a second communications technology or both the first link and the second link.

In step 510, the method comprises determining, by the communications network node, a rule for transmitting the traffic. In step 520, the method further comprises providing the rule to the CPE apparatus for transmitting the traffic from the user device to the communications network, wherein the rule comprises an indication for the CPE apparatus to transmit the traffic to the communications network using the first link, the second link or both the first link and the second link.

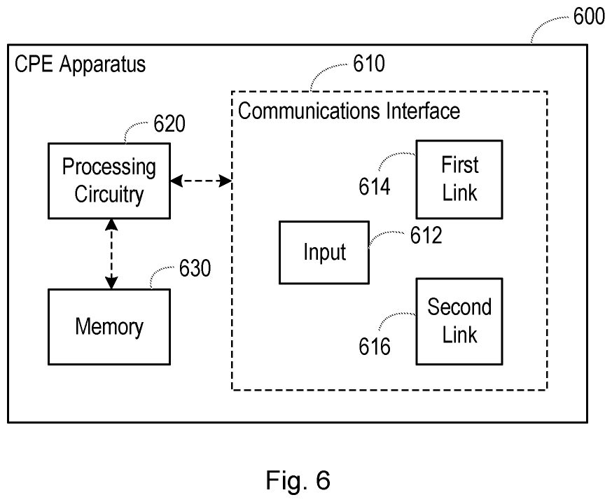

FIG. 6 illustrates a CPE apparatus 600 for transmitting traffic between a user device and a communications network, in accordance with embodiments of the present disclosure. CPE apparatus 600 comprises an input 612 configured to receive traffic from the user device. The CPE apparatus 600 also comprises a first link 614 configured to transmit the traffic to the communications network using a first communications technology. The CPE apparatus 600 further comprises a second link 616 configured to transmit the traffic to the communications network using a second communications technology.

CPE apparatus 600 comprises processing circuitry 620. The processing circuitry 620 controls the operation of the CPE apparatus 600 and can implement the method described herein in relation to a CPE apparatus 600, for example the CPE apparatus 330 and/or 430. The processing circuitry 620 can comprise one or more processors, processing units, multi-core processors or modules that are configured or programmed to control the CPE apparatus 600 in the manner described herein. In particular implementations, the processing circuitry 620 can comprise a plurality of software and/or hardware modules that are each configured to perform, or are for performing, individual or multiple steps of the method described herein in relation to CPE apparatus 600.

Briefly, the processing circuitry 620 of the CPE apparatus 600 is configured to: receive a rule from the communications network for transmitting the traffic and select the first link 614, the second link 616 or both the first and second links to transmit the traffic to the communications network, based on the rule.

In some embodiments, the CPE apparatus 600 may optionally comprise a communications interface 610. The communications interface may, in some examples, comprise input 612, first link 614 and second link 616. The communications interface 610 of the CPE apparatus 600 can be for use in communicating with other nodes, such as a communications network node. For example, the communications interface 610 of the CPE apparatus 600 can be configured to transmit to and/or receive from other nodes requests, resources, information, data, signals, or similar. The processing circuitry 620 of the CPE apparatus 600 may be configured to control the communications interface 610 of the CPE apparatus 600 to transmit to and/or receive from other nodes requests, resources, information, data, signals, or similar.

Optionally, the CPE apparatus 600 may comprise a memory 630. In some embodiments, the memory 620 of the CPE apparatus 600 can be configured to store program code that can be executed by the processing circuitry 620 of the CPE apparatus 600 to perform the method described herein in relation to the CPE apparatus 600. Alternatively or in addition, the memory 630 of the CPE apparatus 600, can be configured to store any requests, resources, information, data, signals, or similar that are described herein. The processing circuitry 620 of the CPE apparatus 600 may be configured to control the memory 630 of the CPE apparatus 600 to store any requests, resources, information, data, signals, or similar that are described herein.

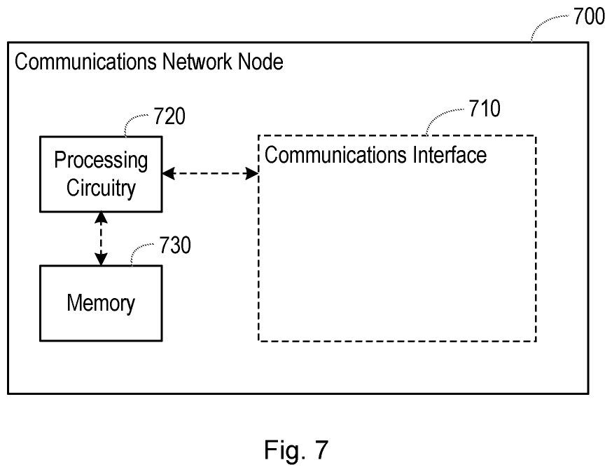

FIG. 7 illustrates a communications network node 700, in a communications network, configured to control transmission of traffic from a user device to the communications network, via a CPE apparatus, wherein the communications network is configured to receive the traffic from the CPE apparatus using: a first link using a first communications technology, a second link using a second communications technology or both the first link and the second link.

Communications network node 700 comprises processing circuitry 720. The processing circuitry 720 controls the operation of the communications network node 700 and can implement the method described herein in relation to a communications network node 700, for example the configuration server 364. The processing circuitry 720 can comprise one or more processors, processing units, multi-core processors or modules that are configured or programmed to control the communications network node 700 in the manner described herein. In particular implementations, the processing circuitry 720 can comprise a plurality of software and/or hardware modules that are each configured to perform, or are for performing, individual or multiple steps of the method described herein in relation to communications network node 700.

Briefly, the processing circuitry 720 of the communications network node 700 is configured to: determine a rule for transmitting the traffic and transmit the rule to the CPE apparatus for transmitting the traffic from the user device to the communications network, wherein the rule comprises an indication for the CPE apparatus to transmit the traffic to the communications network using the first link, the second link or both the first link and the second link.

In some embodiments, the communications network node 700 may optionally comprise a communications interface 710. The communications interface 710 of the communications network node 700 can be for use in communicating with other nodes, such as a CPE apparatus. For example, the communications interface 710 of the communications network node 700 can be configured to transmit to and/or receive from other nodes requests, resources, information, data, signals, or similar. The processing circuitry 720 of the communications network node 700 may be configured to control the communications interface 710 of the communications network node 700 to transmit to and/or receive from other nodes requests, resources, information, data, signals, or similar.

Optionally, the communications network node 700 may comprise a memory 730. In some embodiments, the memory 720 of the communications network node 700 can be configured to store program code that can be executed by the processing circuitry 720 of the communications network node 700 to perform the method described herein in relation to the communications network node 700. Alternatively or in addition, the memory 730 of the communications network node 700, can be configured to store any requests, resources, information, data, signals, or similar that are described herein. The processing circuitry 720 of the communications network node 700 may be configured to control the memory 730 of the communications network node 700 to store any requests, resources, information, data, signals, or similar that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

1. A method of transmitting traffic between a Customer Premises Equipment (CPE) apparatus and a communications network, the method comprising:
receiving traffic from a user device at the CPE apparatus;
providing a first link configured to transmit the traffic to the communications network using a first communications technology;
providing a second link configured to transmit the traffic to the communications network using a second communications technology;
receiving a rule from the communications network at the CPE apparatus for use in transmitting the traffic to the communications network; and
selecting to transmit the traffic to the communications network using the first link, the second link or both the first link and the second link, based on the received rule.

2. The method of claim 1 further comprising:
receiving a plurality of rules from the communications network;
matching the traffic to a corresponding one of the rules in the plurality of rules; and
transmitting the traffic to the communications network according to the corresponding rule.

3. (canceled)

4. (canceled)

5. The method of claim 1, further comprising requesting, by the CPE apparatus, the rule from the communications network.

6. The method of claim 5, wherein the CPE apparatus requests the rule from the communications network upon initialization of the CPE apparatus or upon a request from the user device to connect to the communications network.

7. (canceled)

8. (canceled)

9. A Customer Premises Equipment (CPE) apparatus for transmitting traffic between a user device and a communications network, comprising:
an input configured to receive traffic from the user device;
a first link configured to transmit the traffic to the communications network using a first communications technology;
a second link configured to transmit the traffic to the communications network using a second communications technology; and
processing circuitry configured to:
receive a rule from the communications network for transmitting the traffic; and
select the first link, the second link or both the first link and the second link to transmit the traffic to the communications network, based on the rule.

10. The CPE apparatus of claim 9, wherein the processing circuitry is further configured to:
receive a plurality of rules from the communications network;
match the traffic to a corresponding one of the rules in the plurality of rules; and
transmit the traffic to the communications network according to the corresponding rule.

11. (canceled)

12. (canceled)

13. The CPE apparatus of claim 9, wherein the processing circuitry is further configured to request the rules from the communications network.

14. The CPE apparatus of claim 13, wherein the processing circuitry requests the rule from the communications network upon initialization of the CPE apparatus or upon a request from the user device to connect to the communications network.

15. (canceled)

16. (canceled)

17. A method in a communications network node comprised in a communications network, of controlling transmission of traffic from a user device to the communications network, via a Customer Premises Equipment (CPE) apparatus, wherein the communications network is configured to receive the traffic from the CPE apparatus using: a first link using a first communications technology, a second link using a second communications technology or both the first link and the second link, the method comprising:
determining, by the communications network node, a rule for transmitting the traffic; and
providing the rule to the CPE apparatus for transmitting the traffic from the user device to the communications network; and
wherein the rule comprises an indication for the CPE apparatus to transmit the traffic to the communications network using the first link, the second link or both the first link and the second link.

18. The method of claim 17, wherein determining, the rule for transmitting the traffic comprises:
determining traffic characteristics of the traffic; and
assigning the rule for transmitting the traffic based on the traffic characteristics.

19. The method of claim 17, wherein determining, the rule for transmitting the traffic comprises:
determining network characteristics; and
assigning the rule for transmitting the traffic based on the network characteristics.

20. The method of claim 17, wherein determining, the rule for transmitting the traffic comprises:
determining a policy for the traffic; and
assigning the rule for the traffic based on the policy.

21. (canceled)

22. The method of claim 17, further comprising receiving a request from the CPE apparatus for the rule.

23. (canceled)

24. (canceled)

25. A communications network node, in a communications network, configured to control transmission of traffic from a user device to the communications network, via a Customer Premises Equipment (CPE) apparatus, wherein the communications network is configured to receive the traffic from the CPE apparatus using: a first link using a first communications technology, a second link using a second communications technology or both the first link and the second link, the communications network node comprising:
processing circuitry configured to:
determine a rule for transmitting the traffic; and
transmit the rule to the CPE apparatus for transmitting the traffic from the user device to the communications network;
wherein the rule comprises an indication for the CPE apparatus to transmit the traffic to the communications network using the first link, the second link or both the first link and the second link.

26. The communications network node of claim 25, wherein to determine the rule for transmitting the traffic, the processing circuitry is configured to:
determine traffic characteristics of the traffic; and
assign the rule for transmitting the traffic based on the traffic characteristics.

27. The communications network node of claim 25, wherein to determine the rule for transmitting the traffic, the processing circuitry is configured to:
determine network characteristics; and
assign the rule for transmitting the traffic based on the network characteristics.

28. The communications network node of claim 25, wherein to determine the rule for transmitting the traffic, the processing circuitry is configured to:
determine a policy for the traffic; and
assign the rule for the traffic based on the policy.

29. (canceled)

30. The communications network node of claim 25, wherein the processing circuitry is configured to receive a request from the CPE apparatus for the rule.

31. The communications network node of claim 25, wherein the processing circuitry is further configured to:
detect a trigger;
determine an updated rule in response to the trigger; and
transmit the updated rule to the CPE apparatus.

32. The communications network node of claim 25, wherein to determine the rule for transmitting the traffic, the processing circuitry is further configured to determine a quality of service (QoS) rule for prioritising uplink traffic from the communications network to the user device, and the processing circuitry is further configured to:
transmit uplink traffic from the communications network at the CPE apparatus, wherein the uplink traffic is transmitted to the user device from the CPE apparatus according to the QoS, rule.

33. (canceled)

34. (canceled)
